(19) United States
(12) Patent Application Publication
(10) Pub. No.: US 2009/0271985 A1
(43) Pub. Date: Nov. 5, 2009

(54) REPAIR METHOD

(75) Inventor: Anja Lange, Langenhagen (DE)

Correspondence Address: HOWISON & ARNOTT, L.L.P, P.O. BOX 741715, DALLAS, TX, 75374-1715, US

(73) Assignee: MTU AERO ENGINES GMBH, Munich (DE)

(21) Appl. No.: 12/442,380

(22) PCT Filed: Sep. 13, 2007
(86) PCT No.: PCT/DE07/01647

§ 371 Date: Jun. 5, 2009

(30) Foreign Application Priority Data
Sep. 21, 2006 (DE) 10 2006 044 555.4

(51) Int. Cl. B23P 6/00

(52) U.S. Cl. 29/889.1

(57) ABSTRACT

The invention relates to a method of repairing moving blades of a gas turbine, with at least the following steps: a) preparation of a moving blade to be repaired; b) removal of at least one damaged section of a damaged blade tip of the moving blade to be repaired, forming a parting surface; c) successive building up of the, or each, removed section or the entire blade tip on the parting surface of the moving blade by means of a rapid manufacturing process, using three-dimensional CAD structural data on the moving blade.

### CROSS-REFERENCE TO RELATED APPLICATIONS

This application claims the benefit of Patent Cooperation Treaty Application Serial No. PCT/DE2007/001647, filed Sep. 13, 2007, and entitled REPARATURVERFAHREN, which PCT application claims the benefit of German Application Serial No. DE 10 2006 044 555.4, filed Sep. 21, 2006, and entitled REPARATURVERFARHEN, the specifications of which are incorporated herein by reference in their entirety.

### TECHNICAL FIELD

The invention relates to a method of repairing moving blades of a gas turbine.

### BACKGROUND

The moving blades of gas turbines are subjected to high mechanical and thermal stresses during operation, which can result in the formation of cracks, and to additional stresses caused by wear and tear. Because of these stresses on the moving blades, it can become necessary to repair them when damage has occurred, by removing a damaged portion of the moving blade, especially a blade tip thereof, from the moving blade and replacing it following removal.

From DE 103 19 494 A1 a method of repairing a fixed blade of a gas turbine is known, in which a damaged section is removed from the fixed blade to be repaired, and a replacement part for the removed section is produced by means of a rapid manufacturing process. The replacement part produced via the rapid manufacturing process is integrated into the fixed blade to be repaired via welding or soldering.

Another method of repairing gas turbine blades is known from DE 43 27 189 C2, in which a damaged section of a blade of the gas turbine blade to be repaired is removed, after which a repair plate is welded to the remaining blade stub of the gas turbine blade. The repair plate is then processed to form the desired blade profile.

Common to all of the above repair methods known from the prior art is that, following the removal of a damaged section of a gas turbine blade to be repaired, a replacement part is produced and/or prepared, wherein the produced and/or prepared replacement part is permanently attached to the blade that requires repair.

### SUMMARY

With this as background, the object of the present invention is to devise a novel method of repairing moving blades of a gas turbine.

This object is attained with a repair method in accordance with Claim 1.

In accordance with the invention, the method of repairing moving blades of a gas turbine comprises at least the following steps: a) preparation of a moving blade to be repaired; b) removal of a least one damaged section of a damaged blade tip of the moving blade to be repaired, creating a parting surface; c) successive building up of the, or each, removed section of the blade tip on the parting surface of the moving blade by means of a rapid manufacturing process using three-dimensional CAD structural data on the moving blade.

The present invention provides a method of repairing moving blades of a gas turbine, with which a high quality repair can be implemented. The method of repair in accordance with the invention is suitable for a plurality of types of damage caused to moving blades. The repair method of the invention can be implemented without costly modeling and form construction, and therefore allows a relatively cost-effective repair of moving blades, even in integrally bladed rotors, such as so-called blisks (i.e., bladed disks) and blings (i.e., bladed rings).

In accordance with one advantageous further improvement on the invention, following removal of the, or each, damaged portion of the blade tip from the moving blade, the parting surface is measured, wherein, if an actual shape of the parting surface identified in this manner differs by more than a defined amount from a desired shape of the parting surface determined by the CAD structural data on the moving blade, the CAD structural data are adjusted to the actual shape.

### DETAILED DESCRIPTION

Preferred further improvements on the invention are described in the dependent claims and in the following description. Exemplary embodiments of the invention will be specified in greater detail in what follows, without being thereby restricted.

The present invention relates to a method of repairing moving blades of a gas turbine. Moving gas turbine blades can sustain severe damage in the area of a blade tip during operation, for example as a result of oxidation, corrosion or erosion, such that the damaged blade tip requires full or partial replacement.

To repair a moving blade that is damaged in the area of its blade tip, first the damaged moving blade to be repaired is prepared, after which the damaged blade tip or at least one damaged section thereof is removed from the moving blade to be repaired, creating a parting surface. This also includes sections that extend from the blade tip to the inlet or outlet edge of the blade.

The position of the parting surface or parting line for removal of the section or the damaged blade tip of the moving blade is dependent upon strength requirements on one hand, while on the other hand, the moving blade must be free of coatings and radial cracks in the area of the parting surface.

Within the context of the present invention, it is then proposed to successively build up a new section or a new blade tip on the parting surface, which is formed following the removal of the section or the damaged blade tip, by means of a rapid manufacturing process, wherein three-dimensional CAD structural data on the moving blade are accessed for this purpose. Accordingly, within the context of the present invention, a new section or a new blade tip is built up successively on the parting surface, based upon the three-dimensional CAD structural data on the moving blade. This is accomplished, as mentioned above, using a rapid manufacturing process.

In the rapid manufacturing process, a two-stage process is preferably repeatedly executed. In a first step of the two-stage process, a smooth powder bed comprised of a metal powder is prepared, wherein in a second step, the metal powder of the powder bed is selectively welded on based upon the three-dimensional CAD structural data. By repeatedly executing this two-stage process, the new blade tip is successively built up on the parting surface.

In the first step of the above two-stage process, a metal powder is prepared, the chemical composition of which ideally corresponds to the chemical composition of the moving blade to be repaired. However, at least a metal powder is prepared, which is made of the same basic alloy material as the moving blade to be repaired. If the moving blade to be repaired is made of a nickel base alloy, for example, a metal powder made of a nickel base alloy is used to prepare the smooth powder bed. With each repeated execution of the first step of the two-stage rapid manufacturing process, a powder bed having a maximum thickness of 200 μm is prepared, wherein the average grain size of the metal powder is preferably between 10 μm and 150 μm. The even application of the powder bed can be accomplished using a scraper blade, for example.

In each second step of the two-stage rapid manufacturing process, metal powder is selectively welded onto the parting surface via laser beam welding or via electron beam welding.

With respect to the rapid manufacturing process, it is noted that the moving blade from which the damaged section or the damaged blade tip has been removed is placed in a process chamber of a rapid manufacturing system to execute the rapid manufacturing process. If a plurality of moving blades are to be repaired at the same time in a rapid manufacturing system using the method of the invention, the parting surfaces of the different moving blades must be aligned precisely within one plane.

In the execution of the rapid manufacturing process, the process chamber of the rapid manufacturing system is preferably filled with the metal powder up to the parting surface of the moving blade to be repaired. Alternatively, it is also possible to insert an intermediate base into the rapid manufacturing system, and to fill only the section above the intermediate base with metal powder. In this way, metal powder can be conserved.

To execute the rapid manufacturing process, the process chamber of the rapid manufacturing system is either evacuated or filled with an inert protective gas, thereby preventing oxidation when the powder is being welded onto the parting surface of the moving blade to be repaired.

Optionally, the moving blades are preheated for welding the metal powder on.

In the successive building up of the new section or the new blade tip on the parting surface of the moving blade to be repaired, the new blade tip can be built up with an excess amount toward the outer contour of the moving blade to be repaired. In this case, it is absolutely necessary to post-process the new blade tip.

In accordance with an advantageous further improvement on the repair method of the invention, after the damaged section or the damaged blade tip has been removed from the moving blade, the parting surface that is formed is measured, and the actual shape of the parting surface is thereby identified.

From the knowledge regarding the parting line and the three-dimensional CAD structural data on the moving blade, a desired shape for the parting surface can be derived from the CAD structural data. If the measured actual shape differs from the calculated desired shape by more than a defined amount, it can be provided in accordance with the invention for the CAD structural data to be adjusted to the actual shape such that a transition profile between the actual shape and the desired shape of the parting surface is identified. This makes it possible to compensate for geometric differences between the actual shape and the desired shape of the parting surface, which can result, for example, from wear and tear or from production tolerances.

It is noted that the welding parameters for welding the metal powder on during the rapid manufacturing process should be established based upon the moving blade to be repaired and upon the material thereof and the metal powder. With the suitable selection of the welding parameters, a polycrystalline or monocrystalline, and a purposefully solidified build up of a new blade tip on the parting surface of the moving blade can be accomplished.

In addition, single-stage welding methods, such as laser-powder surfacing, for example, are also suitable for the rapid manufacturing process. In this case, mould-like elements can also be attached to the blade.

A moving blade that has been repaired using the repair method of the invention can then optionally be coated, for example in the area of an inlet side and a delivery side of the moving blade.

1-10. (canceled)

11. A method of repairing moving blades of a gas turbine, with at least the following steps:
preparation of a moving blade to be repaired;
removal of at least one damaged section of a damaged blade tip from the moving blade to be repaired, forming a parting surface;
successive building up of the removed section on the parting surface of the moving blade by means of a rapid manufacturing process, using three-dimensional CAD structural data on the moving blade.

12. A repair method in accordance with claim 11, wherein following removal of the damaged section from the moving blade, the parting surface is measured, wherein, if an actual shape of the parting surface identified in this manner differs by more than a defined amount from an actual shape of the parting surface determined from the CAD structural data on the moving blade, the CAD structural data are adjusted to the actual shape.

13. A repair method in accordance with claim 12, wherein a transition profile between the actual shape and the desired shape is also determined.

14. A repair method in accordance with claim 13, wherein as the rapid manufacturing process, a two-stage process is repeatedly executed, in which
in a first step, a smooth powder bed comprised of a metal powder is prepared, and
in a second step, metal powder of the powder bed is selectively welded on based upon the three-dimensional CAD structural data.

15. A repair method in accordance with claim 11, wherein as the rapid manufacturing process, a two-stage process is repeatedly executed, in which
in a first step, a smooth powder bed comprised of a metal powder is prepared, and
in a second step, metal powder of the powder bed is selectively welded on based upon the three-dimensional CAD structural data.

16. A repair method in accordance with claim 15, wherein in each first step, a smooth powder bed having a maximum thickness of 200 μm is prepared.

17. A repair method in accordance with claim 15, wherein in each first step a powder bed having a grain size of between 10 μm and 150 μm is prepared.

18. A repair method in accordance with claim 15, wherein in each first step a powder bed made of a metal powder is prepared, which is formed from the same basic alloy material as the moving blade to be repaired.

19. A repair method in accordance with claim 15, wherein in each second step the selective welding on of the metal powder is accomplished via laser beam welding.

20. A repair method in accordance with claim 15, wherein in each second step the selective welding on of the metal powder is accomplished via electron beam welding.

21. A repair method in accordance with claim 11, wherein the removed section is built up with surplus material on the parting surface of the moving blade, wherein the repaired blade tip is then post-processed.

22. A method of repairing a blade of a gas turbine for which blade three-dimensional CAD structural data regarding a desired shape exists, the method comprising the following steps:
a) removing a selected section of a blade, thereby forming a parting surface on a remaining section of the blade;
b) covering the parting surface with a powder bed comprising a metal powder;
c) welding the metal powder of the powder bed to the parting surface in selective areas based upon three-dimensional CAD structural data regarding the desired shape of the blade, the newly welded metal powder forming the parting surface for subsequent steps; and
d) successively repeating steps b) and c) until the desired shape of the blade is achieved.

23. A method of repairing a blade in accordance with claim 22, further comprising:
measuring the parting surface following removal of the selected blade section to determine an actual shape of the parting surface, and
adjusting the CAD structural data to the actual shape if the measured shape of the parting surface differs by more than a defined amount from an original CAD shape from the CAD structural data for that portion of the moving blade.

24. A method of repairing a blade in accordance with claim 23, further comprising determining a transition profile between the actual shape and the original CAD shape.

25. A method of repairing a blade in accordance with claim 22, wherein in step b), the parting surface is covered with a smooth powder bed having a maximum thickness of 200 μm.

26. A method of repairing a blade in accordance with claim 22, wherein in step b), the powder bed has a grain size of between 10 μm and 150 μm.

27. A method of repairing a blade in accordance with claim 22, wherein in step c), the welding on of the metal powder is accomplished via one of laser beam welding and electron beam welding.

28. A method of repairing a blade of a gas turbine for which blade three-dimensional CAD structural data regarding a desired shape exists, the method comprising the following steps:
a) removing a selected section of a blade, thereby forming a parting surface on a remaining section of the blade;
b) measuring the parting surface following removal of the selected blade section to determine an actual shape of the parting surface,
c) adjusting the CAD structural data to the actual shape if the measured shape of the parting surface differs by more than a defined amount from an original CAD shape from the CAD structural data for that portion of the moving blade,
d) determining a transition profile between the actual shape and the original CAD shape;
e) covering the parting surface with a powder bed comprising a metal powder;
f) welding the metal powder of the powder bed to the parting surface in selective areas based upon three-dimensional CAD structural data regarding one of the actual shape, the transition profile and the original CAD shape of the blade, the newly welded metal powder forming the parting surface for subsequent steps; and
g) successively repeating steps e) and f) until the desired shape of the blade is achieved.

29. A method of repairing a blade in accordance with claim 28, wherein in step e), the parting surface is covered with a smooth powder bed having a maximum thickness of 200 μm.

30. A method of repairing a blade in accordance with claim 28, wherein in step f), the welding on of the metal powder is accomplished via one of laser beam welding and electron beam welding.
